(19) United States
(12) Patent Application Publication
(10) Pub. No.: US 2001/0034923 A1
(43) Pub. Date: Nov. 1, 2001

(54) Carrying handle of luggage

(75) Inventor: Min Jung Ho, Wu Ku City (TW)

Correspondence Address: WARE FRESSOLA VAN DER SLUYS &, ADOLPHSON, LLP, BRADFORD GREEN BUILDING 5, 755 MAIN STREET, P O BOX 224, MONROE, CT, 06468, US

(73) Assignee: Chaw Khong Technology Co., Ltd.

(21) Appl. No.: 09/801,887

(22) Filed: Mar. 8, 2001

(30) Foreign Application Priority Data
Apr. 27, 2000 (TW) 089206945

(51) Int. Cl. E05B 1/00

(52) U.S. Cl. 16/114.1

(57) ABSTRACT

A carrying handle of luggage comprises a carrying handle, which includes a thick arcuate center portion and an elongated thin elastic member having a hole at either end, two fixed members provided at both ends of the carrying handle, each of them including a front opening and an internal groove, and two sliding blocks secured to the elastic member of the carrying handle that are slidable within the fixed members, wherein the sliding blocks are incurred to move toward each other in the grooves when the carrying handle is lifted, thereby raising the carrying handle. By adopting this design, a carrying handle with a minimized projection space is provided to reduce the luggage's storage space.

### BACKGROUND OF THE INVENTION

1. Field of the Invention

The present invention relates to the field of carrying handle and more particularly to a carrying handle of luggage, which occupies the minimum projection space.

2. Description of Related Art

Recently, more and more luggage handles in the market are made to be retractable; i.e., the luggage handles which can be retracted into a bezel on the top of the luggage so as to facilitate the luggage's easy storage. However, so far there is no disclosed carrying handle of luggage whose design objective is to try to reduce the projected space of the carrying handle to accommodate the luggage's various storage situations.

### SUMMARY OF THE INVENTION

It is therefore an objective of the present invention to provide a design of the carrying handle of luggage with a minimum projection space in order to reduce the luggage handle's storage space.

Another objective of the present invention is to produce a carrying handle of luggage, which has the advantages of simple components and durability.

To achieve the above-mentioned and other objectives, the present invention provides a carrying handle assembly of luggage, which comprises a carrying handle including a center portion and an elastic member, two fixed members provided at both ends of the carrying handle, and two sliding blocks secured to the elastic member within the carrying handle. The carrying handle includes a thick arcuate center portion and an elongated thin elastic member which has one hole drilled at each end. Each of the two fixed members provided at both ends of the carrying handle includes a front opening, a front extension, and an internal groove. The two sliding blocks secured to the elastic member of the carrying handle are slidable within the fixed members, wherein the sliding blocks are induced to move toward each other in the grooves when the carrying handle is lifted, and the luggage handle is thereby raised. By adopting such a design, a carrying handle of luggage with a minimum projection space to reduce the luggage's storage space is herein disclosed.

The above and other objectives, features, and advantages of the present invention will become apparent by a reading of the following detailed description made in conjunction with the accompanying drawings.

### BRIEF DESCRIPTION OF THE DRAWINGS

FIG. 1 is an exploded view of a first preferred embodiment of the carrying handle assembly according to the invention;

FIG. 2 is a bottom angled view of the fixed member of the carrying handle assembly of FIG. 1;

FIG. 3 is a cross-sectional view of the assembled carrying handle assembly of FIG. 1;

FIG. 4 is similar to FIG. 3, where the carrying handle is lifted;

FIG. 5 is a perspective view of the carrying handle assembly mounted on a conventional luggage piece;

FIG. 6 is similar to FIG. 5, where the carrying handle is lifted; and

FIG. 7 is a cross-sectional view of a second preferred embodiment of the carrying handle assembly according to the invention.

### DETAILED DESCRIPTION OF THE PREFERRED EMBODIMENTS

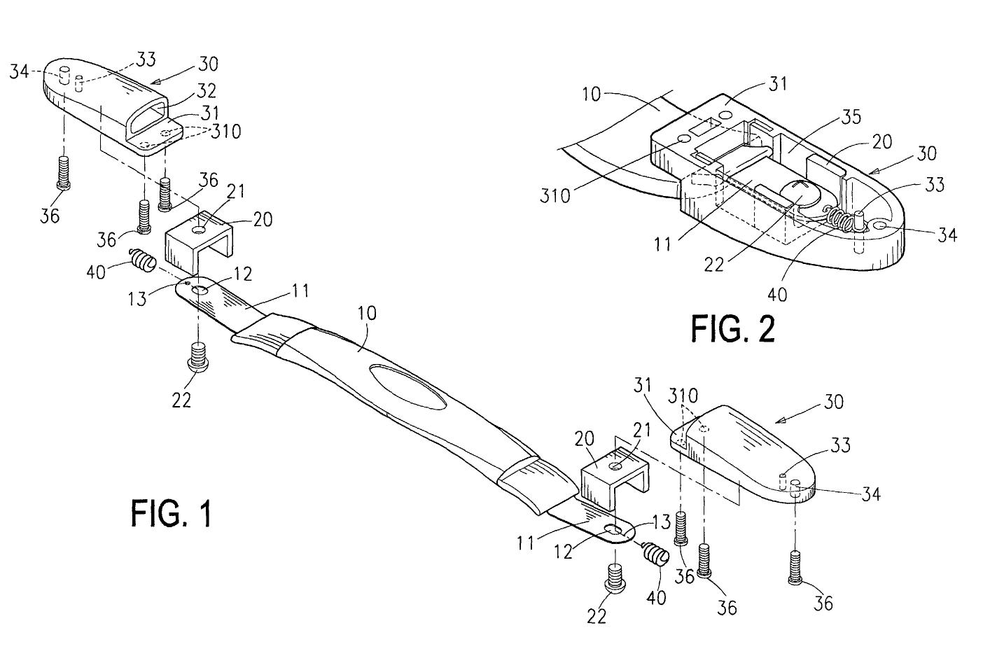

FIGS. 1 to 4 show a carrying handle assembly constructed in accordance with the present invention, which comprises a carrying handle 10, two fixed members 30 at both ends of the carrying handle 10, two sliding blocks 20 secured to the two ends of the carrying handle 10, which are slidable within the fixed members 30, and two springs (e.g., two helical springs) 40, each connected between the carrying handle 10 and the fixed member 30.

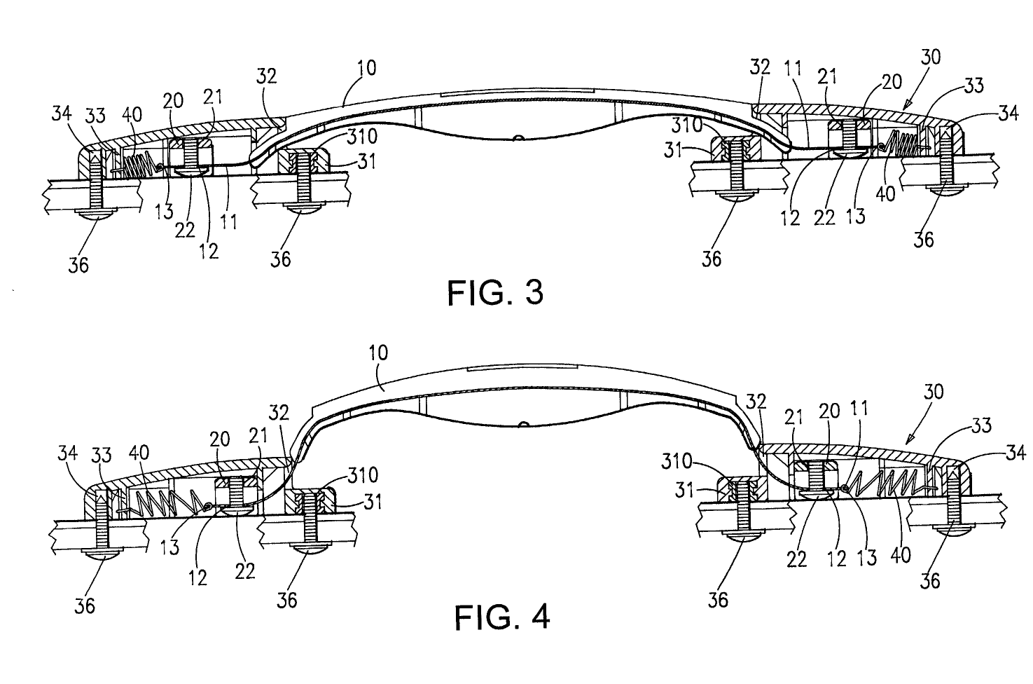

FIGS. 3 and 4 show the carrying handle 10 having a relatively thick arcuate center portion for providing a comfortable grip and an elongated thin elastic member 11, which extends through the carrying handle 10 (i.e., the length of the elastic member 11 is longer than that of the carrying handle 10 and thus protrudes from the carrying handle 10 at both ends). The elastic member 11 is made of a plastic material, which has an acceptable strength. The elastic member 11 is further integrated with the rigid body of the plastic carrying handle 10. It is appreciated by those skilled in the art that the elastic member 11 may be omitted if the plastic carrying handle 10 is strong enough to hold up the luggage's full weight.

Each end of the elastic member 11 comprises a larger hole 12 and a smaller hole 13. The larger hole 12 may be formed in an elongated shape if a taller vertical projection of the carrying handle 10 on top of the luggage is desired.

FIGS. 1 and 2 show the fixed member 30 comprised of an opening 32 for receiving the elastic member 11 of the carrying handle 10 and a front extension 31 at the proximate end. The front extension 31 has two spaced holes 310 such that the fixed member 30 may be secured to the luggage by threading the screws 36 into the holes 310.

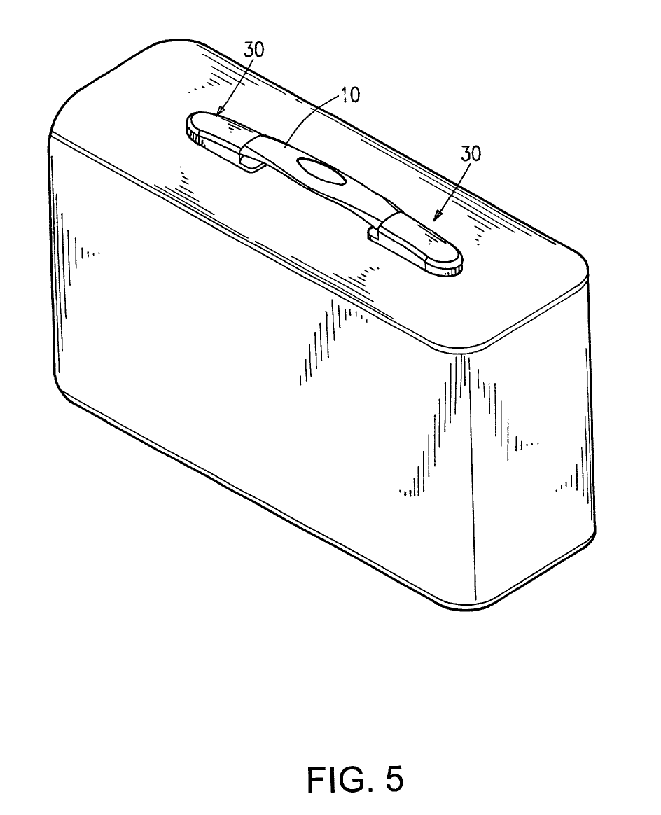

The fixed member 30 further comprises a hole 34 and a post 33 (see FIG. 2). A screw 36 is threaded through the hole 34 to secure the fixed member 30 onto the luggage. A groove 35 is provided in the fixed member 30 to allow the sliding block 20 to slide therein. The sliding block 20 comprises a hole 21 on the top, and it has a U-shaped cross section. A screw 22 is threaded through the hole 12 of the carrying handle 10 and the hole 21 of the sliding block 20 to secure the sliding block 20 and the carrying handle 10 together (see FIGS. 2, 3, and 4). One end of the spring 40 is anchored at the erected post 33, while the other end is anchored at hole 13 of the extended portion of the carrying handle 10, i.e., the elastic member 11 (see FIG. 2). An assembled carrying handle is shown in FIGS. 3 and 5.

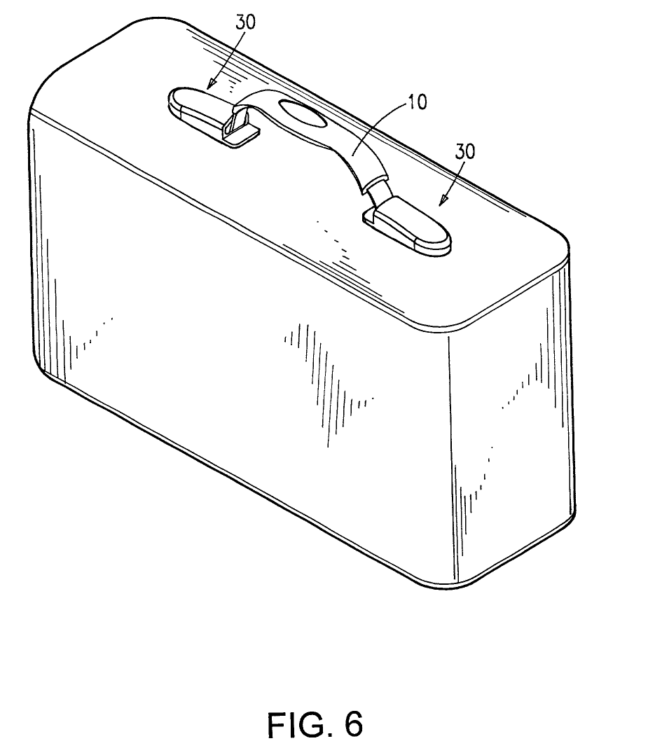

FIGS. 4 and 6 illustrate a description of the use of the carrying handle 10. The sliding blocks 20 are slidable in the grooves 35 and are induced to move toward each other when the carrying handle 10 is lifted. The spring 40 is then expanded, and the carrying handle 10 is raised accordingly (see FIGS. 4 and 6). To the contrary, due to the retraction process of the expansion spring 40, the carrying handle 10 is spontaneously returned to a substantially flat state when it is not lifted (see FIGS. 3 and 5). It is understood that a flat carrying handle assembly is implemented if the fixed members 30 and the carrying handle 10 are made as thin as possible. Also, a considerable height change of the carrying handle 10 is acquirable if the tunnel groove 35 is to be made as long as possible.

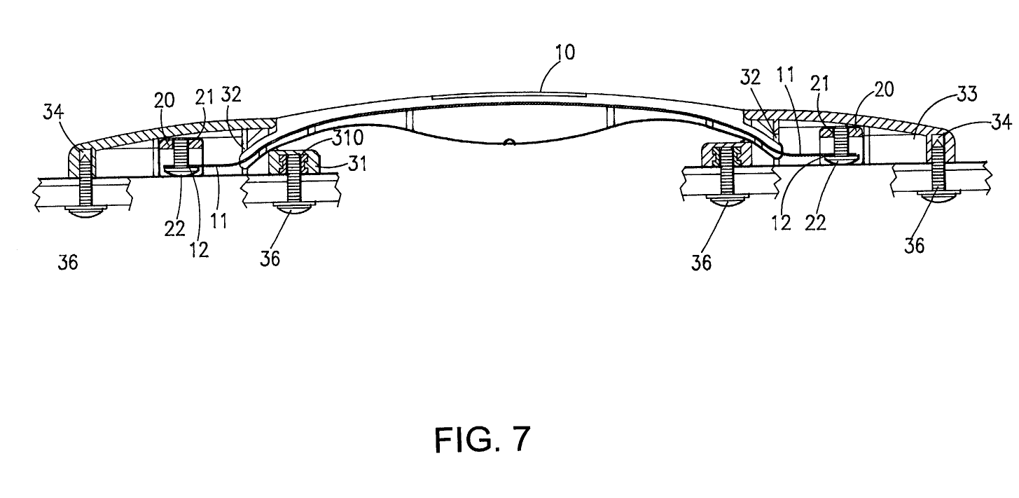

A second preferred embodiment of the carrying handle assembly is shown in FIG. 7. This embodiment is generally the same as the first one except that the springs 40 are omitted. Similar to what is shown in FIG. 6, the handle grip is lifted when the carrying handle 10 is raised by the user, thus, accommodating the carrying of the luggage body. However, when the user decides to release the luggage and keep it at rest for a while, the user has to manually depress the handle grip and flatten the carrying handle 10 in order to level off the luggage handle. It is appreciated by those skilled in the art that the hole 12 may be made as prolonged as possible (in other words, the longer axis of the elliptical profile shaped hole 12 is further lengthened) so as to obtain a significant height change of the carrying handle 10.

It is also appreciated by those skilled in the art that the carrying handle 10 may be omitted if the sliding block 20 and the elastic member 11 are formed integrally.

While the invention herein disclosed has been described by means of specific embodiments, numerous modifications and variations could be made thereto by those skilled in the art without departing from the scope and spirit of the invention set forth in the claims.

What is claimed is:

1. A carrying handle of luggage comprising:
a carrying handle including a thick arcuate center portion and an elongate thin elastic member having a hole at both ends;
two fixed members provided at both ends of the carrying handle including a front opening, a front extension, and an internal groove; and
two sliding blocks secured to the ends of the elastic member of the carrying handle and slidable within the fixed members;
wherein the sliding blocks are induced to move toward each other in the grooves when the carrying handle is lifted, thereby raise the carrying handle.

2. The carrying handle of luggage of claim 1, further comprising two springs each connected between the carrying handle and the fixed member such that the carrying handle is capable of returning to a substantially flat state when the carrying handle is not lifted.

3. The carrying handle of luggage of claim 1, wherein the arcuate center portion and the elastic member of the carrying handle are formed integrally and the length of the elastic member is longer than that of the carrying handle.
